(19) United States
(12) Patent Application Publication
(10) Pub. No.: US 2026/0002904 A1
(43) Pub. Date: Jan. 1, 2026

(54) MICROFLUIDIC ELECTROPHORESIS-MEDIATED CHARACTERIZATION OF PLASMID DNA ISOFORMS

(71) Applicant: Revvity Health Sciences, Inc., Waltham, MA (US)

(72) Inventors: Dipti Rasiklal MEHTA, Waltham, MA (US); James WHITE, Waltham, MA (US); Menel BEN FREJ, Waltham, MA (US); Shreyas SHAH, Waltham, MA (US); Lloyd BWANALI, Waltham, MA (US)

(21) Appl. No.: 19/253,068

(22) Filed: Jun. 27, 2025

Related U.S. Application Data
(60) Provisional application No. 63/665,980, filed on Jun. 28, 2024.

(51) Int. Cl. G01N 27/447; G01N 21/64

(52) U.S. Cl. CPC G01N 27/44726; G01N 21/6486; G01N 27/44791

(57) ABSTRACT

Methods of assessing double-stranded plasmid DNA isoforms to determine a proportion of supercoiled plasmid DNA compared to linear plasmid DNA, and/or open circle plasmid DNA are provided according to aspects of the present disclosure, which include: preferentially labelling double-stranded plasmid DNA; flowing the labeled double-stranded plasmid DNA through a polymeric separation medium in a microchannel into a detection region; detecting the detectable label to determine: a) an amount of time taken by the labeled plasmid DNA isoforms to flow through the polymeric separation medium in the microchannel into the detection region, and/or b) strength of the signal of the detectable label in the detection region; and comparing a) and/or b) to a reference standard thereby determining a proportion of supercoiled plasmid DNA compared to linear plasmid DNA, and/or open circle plasmid DNA in the fluid sample comprising plasmid DNA.

### REFERENCE TO RELATED APPLICATION

This application claims priority from U.S. Provisional Patent Application Ser. No. 63/665,980, filed Jun. 28, 2024, the entire content of which is incorporated herein by reference.

### FIELD OF THE INVENTION

The present disclosure relates generally to assessment of plasmid DNA (pDNA) in a sample to determine one or more characteristics of the pDNA in the sample such as proportion, amount, and size, of supercoiled pDNA, open circular pDNA, and linear pDNA in the sample. According to specific aspects of the present disclosure, methods of assessing plasmid DNA (pDNA) of a sample using microfluidic electrophoresis is detailed which provides determination one or more characteristics of the pDNA in the sample such as proportion, amount, and size, of supercoiled pDNA, open circular pDNA, and linear pDNA in the sample.

### BACKGROUND OF THE INVENTION

Plasmid DNA is an increasingly important delivery vector for gene therapy applications. Supercoiled plasmid DNA is quite stable and has the highest efficiencies of both expression and transduction making supercoiled plasmid DNA the most desirable form of plasmid DNA for use in applications such as DNA vaccines and gene therapy. However, plasmid DNA is subject to degradation during production and storage processes, resulting in open circular and/or linear forms of plasmid DNA which are less optimal. The FDA has recommended a supercoiled plasmid DNA content of preferably greater than 80% (Guidance for Industry, Considerations for Plasmid DNA Vaccines for Infectious Disease Indications, November 2007, 11 pages, Page 3). However, current methods of assessing pDNA are slow and unreliable. Thus, there is a continuing need for improved methods of assessment of plasmid DNA (pDNA) in a sample to determine one or more characteristics of the pDNA in the sample.

### BRIEF SUMMARY

Methods of assessing double-stranded plasmid DNA isoforms to determine a proportion of supercoiled plasmid DNA compared to linear plasmid DNA, and/or open circle plasmid DNA in a fluid sample which includes one or more double-stranded plasmid DNA isoforms, are provided according to aspects of the present disclosure, which include: contacting the double-stranded plasmid DNA isoforms of the fluid sample with a detectable label which preferentially labels double-stranded plasmid DNA thereby labeling linear double-stranded plasmid DNA supercoiled double-stranded plasmid DNA, and open circle double-stranded plasmid DNA, producing labeled double-stranded plasmid DNA; flowing the labeled double-stranded plasmid DNA through a polymeric separation medium in a microchannel into a detection region in fluid communication with the microchannel, the microchannel having a first end, a second end, and length extending between the first end and the second end, the detection region in signal communication with at least one sensor capable of detecting a signal from the detectable label of the labeled double-stranded plasmid DNA, whereby supercoiled double-stranded plasmid DNA, linear double-stranded plasmid DNA, and open circle double-stranded plasmid DNA present in the labeled double-stranded plasmid DNA are detectably separated by flowing the labeled double-stranded plasmid DNA through the polymeric separation medium of the microchannel; detecting the detectable label of the labeled double-stranded plasmid DNA in the detection region to determine: a) an amount of time taken by the labeled plasmid DNA isoforms to flow through the polymeric separation medium in the microchannel into the detection region, indicative of a flow characteristic of the plasmid DNA isoforms in the fluid sample, and/or b) strength of the signal of the detectable label in the detection region, representative of the amount of supercoiled plasmid DNA, linear plasmid DNA, and open circle plasmid DNA present; and comparing a) and/or b) to a reference standard representative of one or more of: supercoiled plasmid DNA, linear plasmid DNA, and open circle plasmid DNA, and, based on the comparison, determining a proportion of supercoiled plasmid DNA compared to linear plasmid DNA, and open circle plasmid DNA in the fluid sample; thereby determining a proportion of supercoiled plasmid DNA compared to linear plasmid DNA, and/or open circle plasmid DNA in the fluid sample comprising plasmid DNA.

According to aspects of the present disclosure, the detectable label is an intercalating agent.

According to aspects of the present disclosure, labeling the plasmid DNA comprises introducing the plasmid DNA into a well and/or microchannel of a microfluidic device, the well and/or microchannel comprising the polymeric separation medium and a detectable label which labels plasmid DNA isoforms producing labeled plasmid DNA isoforms in the well and/or microchannel.

According to aspects of the present disclosure, the plasmid DNA has a size in the range of about 2000 to about 19000 nucleic acid base pairs in length.

According to aspects of the present disclosure, the plasmid DNA has a concentration in the range of about 0.025 ng/μl to about 50.0 ng/μl.

According to aspects of the present disclosure, flowing the labeled plasmid DNA through the polymeric separation medium comprises application of a voltage gradient along the length of the microchannel between the first end and the second end, wherein the voltage gradient is in the range of about 1500V to about 2900V.

According to aspects of the present disclosure, the labeled plasmid DNA is introduced into the well and/or microchannel by electrokinetic injection or pressure injection.

According to aspects of the present disclosure, the polymeric separation medium comprises a polymer selected from the group consisting of: about 0.08% to about 0.6% hydroxypropyl methylcellulose (HPMC), having an average molecular weight in the range of about 80 kDa to about 120 kDa; about 0.08% to about 0.6% HPMC, having an average molecular weight in the range of about 90 kDa to about 160 kDa; about 0.08% to about 0.6% hydroxyethyl cellulose (HEC) having an average molecular weight in the range of about 90 kDa to about 160 kDa; about 0.08% to about 0.6% polyvinylpyrrolidone (PVP) having an average molecular weight in the range of about 90 kDa to about 130 kDa; about 0.05% to about 0.6% polydimethylacrylamide (PDMA), having an average molecular weight in the range of about 80 kDa to about 800 kDa; about 5% polyacrylamide gel; and non-cross-linked polyacrylamide.

According to aspects of the present disclosure, the polymeric separation medium comprises a buffer selected from the group consisting of: 1 mM-5 mM MgCl₂ (magnesium chloride); Tris Borate EDTA Buffer; HEPES (2-[4-(2-hydroxy ethyl) piperazin-1-yl] ethane sulfonic acid) with boric acid; Tris Buffer, and TAPS buffer (N-Tris(hydroxymethyl)methyl-3-aminopropanesulfonic acid).

According to aspects of the present disclosure, the polymeric separation medium comprises a stabilizer.

According to aspects of the present disclosure, the stabilizer is selected from the group consisting of: urea, magnesium chloride (MgCl₂), tris(hydroxymethyl)methylamino]propanesulfonic acid (TAPS), Tris/Borate/EDTA (TBE), and Tris-acetate-EDTA (TAE)

According to aspects of the present disclosure, the polymeric separation medium comprises: about 0.1% to about 0.6% polymer gel; about 5% to about 30% TAPS buffer (N-Tris(hydroxymethyl)methyl-3-aminopropanesulfonic acid), and about 0.1M to about 1M Urea, has a conductivity of about 1 ms/cm to about 3 ms/cm, and has a viscosity of about 0.2 ml/g to about 0.5 ml/g.

According to aspects of the present disclosure, the polymeric separation medium comprises: about 0.1% to about 0.6% polydimethylacrylamide (PDMA), having an average molecular weight in the range of about 80 kDa to about 800 kDa; about 5% to about 30% TAPS buffer (N-Tris(hydroxymethyl)methyl-3-aminopropanesulfonic acid), and about 0.1M to about 1M Urea, has a conductivity of about 1 ms/cm to about 3 ms/cm, and has a viscosity of about 0.2 ml/g to about 0.5 ml/g

Kits for assessing a proportion of supercoiled plasmid DNA compared to linear plasmid DNA, and/or open circle plasmid DNA in a fluid sample comprising plasmid DNA are provided according to aspects of the present disclosure which include a detectable nucleic acid label which labels double-stranded plasmid DNA isoforms, a polymeric separation medium, a nucleic acid standard, a nucleic acid storage buffer, and a nucleic acid sample buffer. According to aspects of the present disclosure, the detectable nucleic acid label is fluorescent nucleic acid intercalator. According to aspects of the present disclosure, the nucleic acid standard is a DNA ladder.

### BRIEF DESCRIPTION OF THE DRAWINGS

FIG. 1 is a schematic illustration of a microfluidic chip containing wells and schematically illustrating channels in fluid connection;

FIG. 2 is a drawing schematically illustrating supercoiled, linear, and circular double-stranded plasmid DNA isoforms detectably labelled with a fluorescent intercalator dye (represented by small circles);

FIG. 3 is a graph illustrating results of a method of method of assessing a proportion of supercoiled double-stranded plasmid DNA compared to linear double-stranded plasmid DNA, and/or open circle double-stranded plasmid DNA in a fluid sample comprising plasmid DNA, showing clear separation of peaks representing supercoiled double-stranded plasmid DNA (left), linear double-stranded plasmid DNA (center), and open circle double-stranded plasmid DNA (right);

FIG. 4 is a graph illustrating results of a method of assessing a proportion of supercoiled double-stranded plasmid DNA compared to linear double-stranded plasmid DNA, and/or open circle double-stranded plasmid DNA in a fluid sample comprising plasmid DNA, showing clear separation of peaks representing supercoiled double-stranded plasmid DNA (left), linear double-stranded plasmid DNA (center), and open circle double-stranded plasmid DNA (right), as well as separate graph lines showing the different forms of the plasmid DNA separately;

FIG. 5 is a graph illustrating results of a method of assessing a proportion of supercoiled double-stranded plasmid DNA compared to linear double-stranded plasmid DNA, and/or open circle double-stranded plasmid DNA in a fluid sample comprising plasmid DNA, showing clear separation of peaks representing supercoiled double-stranded plasmid DNA (left), linear double-stranded plasmid DNA (center), and open circle double-stranded plasmid DNA (right), as well as separate graph lines showing the different forms of the plasmid DNA separately;

FIG. 6A is a graph illustrating differences in peak height comparison between the linear DNA and the pDNA separation conditions;

FIG. 6B is a graph illustrating resolution comparison between the linear DNA and the pDNA separation conditions;

FIG. 6C is a graph illustrating peak height comparison across 0.05, 0.10 and 0.15% weight/weight (w/w) gel concentrations;

FIG. 6D is a graph illustrating resolution comparison across 0.05, 0.10 and 0.15% w/w gel concentrations;

FIG. 6E is a graph illustrating peak height comparison across 2100, 2200, and 2300 V;

FIG. 6F is a graph illustrating resolution comparison across 2100, 2200, and 2300 V;

FIG. 7 is a set of graphs illustrating migration profiles of supercoiled double-stranded plasmid DNA compared to linear double-stranded plasmid DNA;

FIG. 8A is an electropherogram overlay of spiked 10 pg/μL, 25 pg/μL, 50 pg/μL, and 100 pg/μL linear isoform impurity for the 4.4 kbp plasmid, indicating that higher impurity concentrations detected correlate with the increased areas under the impurity peaks;

FIG. 8B is a graph showing that detection of spiked 10 pg/μL, 25 pg/μL, 50 pg/μL, and 100 pg/μL linear isoform impurity shown in FIG. 8A was linear;

FIG. 8C is an electropherogram overlay of spiked 10 pg/μL, 25 pg/μL, 50 pg/μL, and 100 pg/μL open circular isoform impurity for the 4.4 kbp plasmid, indicating that higher impurity concentrations detected correlate with the increased areas under the impurity peaks;

FIG. 8D is a graph showing that detection of spiked 10 pg/μL, 25 pg/μL, 50 pg/μL, and 100 pg/μL open circular isoform impurity shown in FIG. 8C was linear;

FIG. 9A is a graph displaying 16 electropherograms of the supercoiled isoform of an 18.9 kbp plasmid;

FIG. 9B is a graph displaying 16 electropherograms of the linear isoform of an 18.9 kbp plasmid;

FIG. 9C is a graph displaying 16 electropherograms of samples containing a mixture of the linear isoform and the supercoiled isoform, and containing the open circular isoform, of an 18.9 kbp plasmid, and showing resolved peaks of the three isoforms;

FIG. 9D is a table showing “Area Percentage of Plasmids” for the separate or mixed supercoiled and linear isoforms of the 18.9 kbp plasmid; and

FIG. 9E is a graph showing “Migration Time (seconds) of Plasmids)” for the separate or mixed supercoiled and linear isoforms of the 18.9 kbp plasmid.

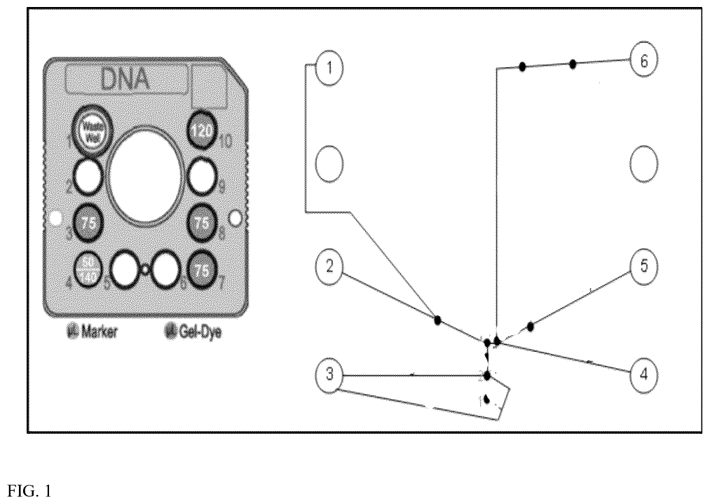

### DETAILED DESCRIPTION

Scientific and technical terms used herein are intended to have the meanings commonly understood by those of ordinary skill in the art. Such terms are found defined and used in context in various standard references illustratively including J. Sambrook and D. W. Russell, Molecular Cloning: A Laboratory Manual, Cold Spring Harbor Laboratory Press; 3rd Ed., 2001; F. M. Ausubel, Ed., Short Protocols in Molecular Biology, Current Protocols; 5th Ed., 2002; B. Alberts et al., Molecular Biology of the Cell, 4th Ed., Garland, 2002; CRISPR/Cas: A Laboratory Manual, Doudna and Mali (eds), Cold Spring Harbor Laboratory Press, Cold Spring Harbor, NY, USA, 2016; D. L. Nelson and M. M. Cox, Lehninger Principles of Biochemistry, 4th Ed., W.H. Freeman & Company, 2004; J.-H. Fuhrhop et al. (Eds.), Organic Synthesis, Concepts and Methods, 3rd Ed., Wiley-VCH Verlag GmbH & Co. KGaA, 2003; Herdewijn, P. (Ed.), Oligonucleotide Synthesis: Methods and Applications, Methods in Molecular Biology, Humana Press, 2004; D. J. Taxman (ed.), siRNA Design, Methods and Protocols, Humana Press, 2012; Harlow, E. and Lane, D., Antibodies: A Laboratory Manual, Cold Spring Harbor Laboratory Press, 1988; J. D. Pound (Ed.) Immunochemical Protocols, Methods in Molecular Biology, Humana Press, 2nd ed., 1998; Chu, E. and Devita, V. T., Eds., Physicians' Cancer Chemotherapy Drug Manual, Jones & Bartlett Publishers, 2021; J. M. Kirkwood et al., Eds., Current Cancer Therapeutics, 4th Ed., Current Medicine Group, 2001; A Adejare (Ed.), Remington: The Science and Practice of Pharmacy, Elsevier, 23rd Ed., 2021; L. V. Allen, Jr. et al., Ansel's Pharmaceutical Dosage Forms and Drug Delivery Systems, 11th Ed., Wolters Kluwer, 2016; and L. Brunton et al., Goodman & Gilman's The Pharmacological Basis of Therapeutics, McGraw-Hill Education, 13th Ed., 2018.

The singular terms “a,” “an,” and “the” are not intended to be limiting and include plural referents unless explicitly stated otherwise or the context clearly indicates otherwise.

The terms “includes,” “comprises,” “including,” “comprising,” “has,” “having,” and grammatical variations thereof, when used in this specification, are not intended to be limiting, and specify the presence of stated features, elements, and/or components, but do not preclude the presence or addition of one or more other features, elements, components, and/or groups thereof.

The term “about” as used herein in reference to a number is used herein to include numbers which are greater, or less than, a stated or implied value by 1%, 5%, 10%, or 20%.

Particular combinations of features are recited in the claims and/or disclosed in the specification, and these combinations of features are not intended to limit the disclosure of various aspects. Combinations of such features not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a alone; b alone; c alone, a and b, a, b, and c, b and c, a and c, as well as any combination with multiples of the same element, such as a and a; a, a, and a; a, a, and b; a, a, and c; a, b, and b; a, c, and c; and any other combination or ordering of a, b, and c).

The terms “first,” “second,” and the like are used herein to describe various features or elements, but these features or elements are not intended to be limited by these terms, but are only used to distinguish one feature or element from another feature or element. Thus, a first feature or element could be termed a second feature or element, and vice versa, without departing from the teachings of the present disclosure.

According to aspects of the present disclosure, a method of assessing a proportion of supercoiled plasmid DNA compared to linear plasmid DNA, and/or open circle plasmid DNA in a fluid sample containing plasmid DNA includes contacting the plasmid DNA with 1) a detectable label which preferentially labels double-stranded plasmid DNA, thereby labeling linear plasmid DNA, supercoiled plasmid DNA, and open circle plasmid DNA with the detectable label, producing labeled plasmid DNA.

The term “plasmid DNA” as used herein refers to a double-stranded DNA cloning vector used to transfer DNA, such as to transfer DNA from one cell type to another, for example to express an encoded peptide or protein. Plasmid DNA can be used to treat diseases, such as use in gene therapy. Plasmid DNA can be used to prevent or inhibit diseases, such as in vaccines.

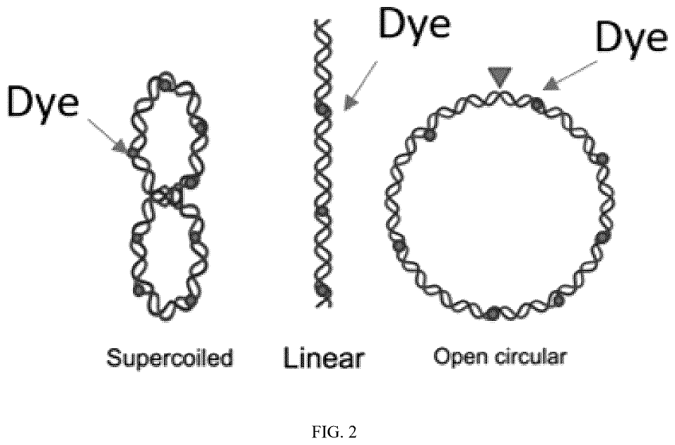

The term “double-stranded plasmid DNA” as used herein refers to plasmid DNA isoforms including 1) linear plasmid DNA, 2) supercoiled plasmid DNA, and 3) open circle plasmid DNA. These isoforms are schematically illustrated in FIG. 2. As used herein, the term “double-stranded plasmid DNA” may include linear plasmid DNA, supercoiled plasmid DNA, and/or open circle plasmid DNA isoforms which include small portions of single-stranded DNA. Typically less than 10% of the total length of the double-stranded plasmid DNA molecule is single-stranded, such as less than about 10%, less than about 5%, less than about 1%, less than about 0.1%, less than about 0.01%, less than about 0.001%, or less than about 0.0001%.

The term “detectable label” refers to a material capable of producing a signal indicative of the presence of a labeled nucleic acid and detectable by any appropriate method illustratively including spectroscopic, optical, photochemical, biochemical, enzymatic, electrical and/or immunochemical. A detectable label allows for detection based on detectable properties of the label, such as, but not limited to, chemical properties, electrical properties, magnetic properties, optical properties, physical properties, or any two or more thereof. The detectable label may include one or more of: a fluorescent label, a bioluminescent label, a chemiluminescent label, a chromophore, a magnetic label, an antibody, an antigen, an enzyme, a substrate, a radioisotope, or any two or more thereof.

According to aspects of the present disclosure, the detectable label is a fluorescent label. A fluorescent label is selected based on fluorophore characteristics including, but not limited to, excitation maximum wavelength and emission maximum wavelength.

Fluorophores used as fluorescent labels can be any of numerous fluorophores including, but not limited to, those described in Haughland, R. P., The Handbook, A Guide to Fluorescent Probes and Labeling Technologies, 10th Ed., 2005; Lakowicz, J. R., Principles of Fluorescence Spectroscopy, Springer, 3rd ed., 2006; 4-acetamido-4′-isothiocyanatostilbene-2,2′disulfonic acid; acridine and derivatives such as acridine and acridine isothiocyanate; 4-amino-N-[3-vinylsulfonyl)phenyl]naphthalimide-3,5 disulfonate, Lucifer Yellow VS; N-(4-anilino-1-naphthyl) maleimide; anthranilamide, Brilliant Yellow; BIODIPY fluorophores (4,4-difluoro-4-bora-3a,4a-diaza-s-indacenes); coumarin and derivatives such as coumarin, 7-amino-4-methylcoumarin (AMC, Coumarin 120), 7-amino-4-trifluoromethylcouluarin (Coumaran 151); cyanosine; DAPOXYL sulfonyl chloride; 4′,6-diaminidino-2-phenylindole (DAPI); 5′,5″-dibromopyrogallol-sulfonephthalein (Bromopyrogallol Red); 7-diethylamino-3-(4′-isothiocyanatophenyl)-4-methylcoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylaminolnaphthalene-1-sulfonyl chloride (DNS, dansyl chloride); 4-4′-dimethylaminophenylazo)benzoic acid (DABCYL); 4-dimethylaminophenylazophenyl-4′-isothiocyanate (DABITC); EDANS (5-[(2-aminoethyl)amino]naphthalene-1-sulfonic acid), eosin and derivatives such as eosin isothiocyanate; erythrosin and derivatives such as erythrosin B and erythrosin isothiocyanate; ethidium such as ethidium bromide; fluorescein and derivatives such as 5-carboxyfluorescein (FAM), hexachlorofluorescenin, 5-(4,6-dichlorotriazin-2-yl)aminofluorescein (DTAF), 2′,7′-dimethoxy-4′,5′-dichloro-6-carboxyfluorescein (JOE) and fluorescein isothiocyanate (FITC); fluorescamine; green fluorescent protein and derivatives such as EBFP, EBFP2, ECFP, and YFP; IAEDANS (5-({2-[(iodoacetyl)amino]ethyl}amino) naphthalene-1-sulfonic acid), Malachite Green isothiocyanate; 4-methylumbelliferone; orthocresolphthalein; nitrotyrosine; pararosaniline; Phenol Red; B-phycoerytnin; o-phthaldialdehyde; pyrene and derivatives such as pyrene butyrate, 1-pyrenesulfonyl chloride and succinimidyl 1-pyrene butyrate; QSY 7; QSY 9; Reactive Red 4 (Cibacron® Brilliant Red 3B-A); rhodamine and derivatives such as 6-carboxy-X-rhodamine (ROX), 6-carboxyrhodamine (Rhodamine 6G), rhodamine isothiocyanate, lissamine rhodamine B sulfonyl chloride, rhodamine B, rhodamine 123, sulforhodamine B, sulforhodamine 101 and sulfonyl chloride derivative of sulforhodamine 101 (Texas Red); N,N,N′,N-tetramethyl-carboxyrhodamine (TAMRA); tetramethyl rhodamine; tetramethyl rhodamine isothiocyanate (TRITC); riboflavin; rosolic acid and terbium chelate derivatives, or any combination of two or more thereof.

According to aspects of the present disclosure, the detectable label is a fluorescent nucleic acid stain. Fluorescent nucleic acid stains include, but are not limited to, Alexa Fluor dyes, BIODIPY dyes, acridine dyes, acridine orange (AO, N,N,N′,N′-Tetramethylacridine-3,6-diamine), cyanine dimer dyes, cyanine monomer dyes, DAPI (4′,6-diamidino-2-phenylindole), DRAQ dyes, ellipticine, ethidium compounds, ethidium bromide, crystal violet, GelRed™, GelGreen™, Hoechst dyes, iodine compounds, 7-aminoactinomycin D, methylene blue, oxazole dyes, PicoGreen, proflavine, propidium iodide (2,7-Diamino-9-phenyl-10 (diethylaminopropyl)-phenanthridium iodide methiodide), SYBR dyes, SYTO dyes, TOTO™ dyes, thiozole dyes, thiazole orange homodimer (TOTO™-1), thiozole red (TO-PRO®-3), thiazole red homodimer (TOTO®-3), oxazole yellow (YO-PRO®-1), oxazole yellow homodimer (YOYO™-1), oxazole red (YO-PRO®-3), oxazole red homodimer (YOYO™-3), oxazole blue (PO-PRO™-1), oxazole blue homodimer (POPO™-1), TO Iodide (TO-PRO™-1), BOBO, JOJO, LOLO, At BO-PRO, JO-PRO, LO-PRO, or any combination of two or more thereof.

According to preferred aspects of the present disclosure, the detectable label is a fluorescent intercalator. The term “intercalator” refers to a moiety that has higher fluorescence emission when bound to DNA compared to when not bound to DNA and which can insert into an intramolecular space of a DNA molecule, such as between stacked bases of DNA or between stacked base pairs of DNA, forming a fluorescent complex that is stable under conditions of microfluidic electrophoresis such as described herein.

Fluorescent intercalators include, but are not limited to, SYBR dyes, SYTO dyes, ellipticine, ethidium bromide, crystal violet, acridine dyes, acridine orange (AO, N,N,N′,N′-Tetramethylacridine-3,6-diamine), methylene blue, propidium iodide (2,7-Diamino-9-phenyl-10 (diethylaminopropyl)-phenanthridium iodide methiodide), pyronin Y (Ammonium, (6-(dimethylamino)-3H-xanten-3-ylidene)dimethyl-, chloride, also known as pyronine G, CAS #92-32-0), RiboGreen, RiboRed, 7-aminoactinomycin D, DAPI (4′,6-diamidino-2-phenylindole), TOTO™ dyes, thiozole dyes, thiazole orange homodimer (TOTO™-1), thiozole red (TO-PRO®-3), thiazole red homodimer (TOTO®-3), cyanine dimer dyes, cyanine monomer dyes, proflavine, Alexa Fluor dyes, and BIODIPY dyes.

For labeling the plasmid DNA, the concentration of the label in the sample, aliquot of the sample, or in the polymeric separation medium is about 0.01 mM to about 0.2 mM, such as about 0.025 mM to about 0.15 mM, about 0.05 mM to about 0.1 mM, about 0.075 mM to about 0.1 mM, about 0.01 mM to about 0.025 mM, about 0.01 mM to about 0.05 mM, about 0.01 mM to about 0.075 mM, or about 0.01 mM to about 0.1 mM.

### Device

Methods of assessing a proportion of supercoiled plasmid DNA compared to linear plasmid DNA, and/or open circle plasmid DNA in a fluid sample containing plasmid DNA according to aspects of the present disclosure include use of a microfluidic device.

Methods of assessing a proportion of supercoiled plasmid DNA compared to linear plasmid DNA, and/or open circle plasmid DNA in a fluid sample containing plasmid DNA according to aspects of the present disclosure include flowing the labeled plasmid DNA through a polymeric separation medium in a microchannel of a microfluidic device.

A microfluidic device used according to aspects of methods of the present disclosure allows for separation of plasmid DNA including supercoiled plasmid DNA, linear plasmid DNA, and open circle plasmid DNA when two or more of these are present in a fluid sample and then detection of the separated plasmid DNA types.

According to aspects of the present disclosure, the microfluidic device is a capillary electrophoresis system that allows for separation of supercoiled plasmid DNA, linear plasmid DNA, and open circle plasmid DNA when two or more of these are present in a fluid sample. According to aspects of the present disclosure, the microfluidic device is, or includes, a microfluidic chip.

A microfluidic device used according to aspects of methods of the present disclosure includes at least one microchannel and may include one or more receptacles in fluid communication with one or more microchannels. The microchannel(s) and/or receptacle(s) are included in the microfluidic device, for example, by etching, bonding, soft lithography, or molding into a material which is substantially insert with respect to the sieving matrix, dyes, nucleic acid and/or proteins, ceramics and semiconductors, such as glass or silicon, or a polymer, such as polydimethylsiloxane (PDMS). Some or all of the microchannel(s) and/or receptacle(s) may be connected in a network as desired and the microchannel(s) and/or receptacle(s) may be in fluid communication with one or more inputs and/or outputs to allow for input and/or output to/from the microfluidic device.

A microchannel of a microfluidic device is made of any material suitable for containing a polymeric separation medium and aliquot of sample while remaining inert to the polymeric separation medium and aliquot of sample, such as, but not limited to, glass, silicon, plastic, quartz, or mixtures of any two or more thereof.

In some aspects, the microchannel has a length in the range of about 25 millimeters to about 250 millimeters, such as about 25 millimeters to about 35 millimeters, about 35 millimeters to about 45 millimeters, about 45 millimeters to about 55 millimeters, about 55 millimeters to about 65 millimeters, about 65 millimeters to about 75 millimeters, about 75 millimeters to about 85 millimeters, about 85 millimeters to about 95 millimeters, about 95 millimeters to about 100 millimeters, about 100 millimeters to about 110 millimeters, about 110 millimeters to about 120 millimeters, about 120 millimeters to about 130 millimeters, about 130 millimeters to about 140 millimeters, about 140 millimeters to about 150 millimeters, about 150 millimeters to about 160 millimeters, about 160 millimeters to about 170 millimeters, about 170 millimeters to about 180 millimeters, about 180 millimeters to about 190 millimeters, about 190 millimeters to about 200 millimeters, about 200 millimeters to about 210 millimeters, about 210 millimeters to about 220 millimeters, about 220 millimeters to about 230 millimeters, about 230 millimeters to about 240 millimeters, or about 240 millimeters to about 250 millimeters.

In some aspects, the microchannel has an internal diameter of between about 1 micron to about 10 millimeters, such as about 1 micron to about 10 microns, about 10 microns to about 20 microns, about 20 microns to about 30 microns, about 30 microns to about 40 microns, about 40 microns to about 50 microns, about 50 microns to about 60 microns, about 60 microns to about 70 microns, about 70 microns to about 80 microns, about 80 microns to about 90 microns, about 90 microns to about 100 microns, about 100 microns to about 200 microns, about 200 microns to about 300 microns, about 300 microns to about 400 microns, about 400 microns to about 500 microns, about 500 microns to about 600 microns, about 600 microns to about 700 microns, about 700 microns to about 800 microns, about 800 microns to about 900 microns, about 900 microns to about 1 millimeter, or about 1 millimeter to about 10 millimeters.

### Polymeric Separation Medium

According to aspects of the present disclosure an included polymeric separation medium is configured to separate different forms of detectably labeled plasmid DNA, i.e. supercoiled plasmid DNA, linear plasmid DNA, and/or circular plasmid DNA, which are, or may be, present in the sample and to obtain a signal from each of the different forms of detectably labeled plasmid DNA, when present, representative of the amount of the different forms of the plasmid DNA present in the sample.

Configuring the polymeric separation medium to separate different forms of detectably labeled plasmid DNA may include, but is not limited to, selection of one or more of: pore size, polymer type, average polymer molecular weight, polymer concentration, cross-linker, extent of polymer cross-linkage, a denaturing agent, a salt, and buffer type.

According to aspects of the present disclosure, the polymeric separation medium, also known as a sieving matrix, is, or includes, a polymer such as, but not limited to, one or more polyacrylamides, polyvinylpyrrolidinones, celluloses, agaroses, or a mixture of any two or more thereof. Polyacrylamides that can be included in the polymeric separation medium include, but are not limited to, linear polyacrylamide, polydimethylacrylamide, polydiethylacrylamide, or a mixture of any two or more thereof. According to aspects of the present disclosure, the polymeric separation medium includes a cellulose polymer, such as, but not limited to, cellulose, hydroxypropyl methylcellulose (HPMC); hydroxyethyl cellulose (HEC); or a mixture of any two or more thereof. According to aspects of the present disclosure, the polymeric separation medium is, or includes, a polymeric gel such as, but not limited to, an acrylamide gel, an agarose gel, or a mixture of any two or more thereof.

The concentration of a polymer in a polymeric separation medium and the viscosity of the polymeric separation medium is adjusted according to the size of the plasmid DNA to be detected. According to aspects of the present disclosure, and included polymeric separation medium has a viscosity in the range of about 5 centistokes (cSt) to 100 cSt.

According to aspects of the present disclosure, the polymeric separation medium includes one or more of: hydroxypropyl methylcellulose (HPMC); hydroxyethyl cellulose (HEC); polyvinylpyrrolidone (PVP); polydimethylacrylamide (PDMA); polyacrylamide gel; and non-cross-linked polyacrylamide.

According to aspects of the present disclosure, a polymer included in the polymeric separation medium is, or includes, a polymer such as, but not limited to, one or more polyvinylpyrrolidinones, celluloses, agaroses, or a mixture of any two or more thereof which is present in a concentration of about 0.08% to about 0.60% weight/weight (w/w) of the total weight of the polymeric separation medium. According to aspects of the present disclosure, a polymer included in the polymeric separation medium is present in a concentration of about 0.08%, about 0.09%, about 0.10%, about 0.11%, about 0.12%, about 0.13%, about 0.14%, about 0.15%, about 0.16%, about 0.17%, about 0.18%, about 0.19%, about 0.20%, about 0.21%, about 0.22%, about 0.23%, about 0.24%, about 0.25%, about 0.26%, about 0.27%, about 0.28%, about 0.29%, about 0.30%, about 0.31%, about 0.32%, about 0.33%, about 0.34%, about 0.35%, about 0.36%, about 0.37%, about 0.38%, about 0.39%, about 0.40%, about 0.41%, about 0.42%, about 0.43%, about 0.44%, about 0.45%, about 0.46%, about 0.47%, about 0.48%, about 0.49%, about 0.50%, about 0.51%, about 0.52%, about 0.53%, about 0.54%, about 0.55%, about 0.56%, about 0.57%, about 0.58%, about 0.59%, or about 0.60% weight/weight (w/w) of the total weight of the polymeric separation medium.

According to aspects of the present disclosure, a polymer included in the polymeric separation medium is, or includes, a cross-linked polyacrylamide, a non-cross-linked polyacrylamide, or a mixture of any two or more thereof which is present in a concentration of 0.05% to 10% weight/weight (w/w) of the total weight of the polymeric separation medium. According to aspects of the present disclosure, a polymer included in the polymeric separation medium is, or includes, a cross-linked polyacrylamide, a non-cross-linked polyacrylamide, or a mixture of any two or more thereof which is present in a concentration of about 0.05%, about 0.10%, about 0.20%, about 0.30%, about 0.40%, about 0.50%, about 0.60%, about 0.70%, about 0.80%, about 0.90%, about 1%, about 2%, about 3%, about 4%, about 5%, about 6%, about 7%, about 8%, about 9%, or about 10% weight/weight (w/w) of the total weight of the polymeric separation medium.

According to aspects of the present disclosure, a polymer included in the polymeric separation medium is, or includes about 5% polyacrylamide.

According to aspects of the present disclosure, the polymeric separation medium includes hydroxypropyl methylcellulose (HPMC) having an average molecular weight in the range of about 80 kDa to about 160 kDa, such as about 80 kDa to about 120 kDa, about 90 kDa to about 160 kDa, about 90 kDa to about 130 kDa, about 100 kDa to about 140 kDa, about 80 kDa to about 110 kDa, about 90 kDa to about 120 kDa, about 100 kDa to about 130 kDa, about 110 kDa to about 140 kDa, about 120 kDa to about 150 kDa, about 130 kDa to about 160 kDa, about 80 kDa to about 100 kDa, about 100 kDa to about 120 kDa, about 120 kDa to about 140 kDa, about 140 kDa to about 160 kDa, about 80 kDa to about 85 kDa, about 85 kDa to about 90 kDa, about 90 kDa to about 95 kDa, about 95 kDa to about 100 kDa, about 100 kDa to about 105 kDa, about 105 kDa to about 110 kDa, about 110 kDa to about 115 kDa, about 115 kDa to about 120 kDa, about 120 kDa to about 125 kDa, about 125 kDa to about 130 kDa, about 130 kDa to about 135 kDa, about 135 kDa to about 140 kDa, about 140 kDa to about 145 kDa, about 145 kDa to about 150 kDa, about 150 kDa to about 155 kDa, or about 155 kDa to about 160 kDa, and present in a concentration of 0.08% to 0.40% weight/weight (w/w) of the total weight of the polymeric separation medium.

According to aspects of the present disclosure, the polymeric separation medium includes HPMC having an average molecular weight in the range of about 80 to about 120 kDa and present in a concentration of about 0.08% to about 0.40% weight/weight (w/w) of the total weight of the polymeric separation medium. According to aspects of the present disclosure, the polymeric separation medium includes HPMC having an average molecular weight in the range of about 90 to about 160 kDa and present in a concentration of about 0.08% to about 0.40% weight/weight (w/w) of the total weight of the Polymeric Separation Medium.

According to aspects of the present disclosure, the polymeric separation medium includes hydroxyethyl cellulose (HEC) having an average molecular weight in the range of about 90 to about 160 kDa and present in a concentration of about 0.08% to about 0.40% weight/weight (w/w) of the total weight of the polymeric separation medium.

According to aspects of the present disclosure, the polymeric separation medium includes polyvinylpyrrolidone (PVP) having an average molecular weight in the range of 90-130 kDa and present in a concentration of about 0.08% to about 0.40% weight/weight (w/w) of the total weight of the polymeric separation medium.

According to aspects of the present disclosure, the polymeric separation medium includes polydimethylacrylamide (PDMA), having an average molecular weight in the range of about 80 kDa to about 800 kDa and present in a concentration of about 0.05% to about 0.40% weight/weight (w/w) of the total weight of the polymeric separation medium. According to aspects of the present disclosure, the polymeric separation medium includes polydimethylacrylamide (PDMA), having an average molecular weight in the range of about 80 kDa to about 800 kDa such as about 100 kDa to about 200 kDa, about 200 kDa to about 300 kDa, about 300 kDa to about 400 kDa, about 400 kDa to about 500 kDa, about 500 kDa to about 600 kDa, about 600 kDa to about 700 kDa, about 700 kDa to about 800 kDa, about 150 kDa to about 800 kDa, about 200 kDa to about 800 kDa, about 250 kDa to about 800 kDa, about 300 kDa to about 800 kDa, about 350 kDa to about 800 kDa, about 400 kDa to about 800 kDa, about 450 kDa to about 800 kDa, about 500 kDa to about 800 kDa, about 550 kDa to about 800 kDa, about 600 kDa to about 800 kDa, about 650 kDa to about 800 kDa, about 700 kDa to about 800 kDa, about 750 kDa to about 800 kDa.

According to aspects of the present disclosure, the polymeric separation medium includes polydimethylacrylamide (PDMA), having an average molecular weight in the range of about 80 kDa to about 800 kDa and present in a concentration of about 0.05% to about 0.60% weight/weight (w/w) of the total weight of the polymeric separation medium, such as about 0.05% to about 0.60%, about 0.10% to about 0.60%, about 0.15% to about 0.60%, about 0.20% to about 0.60%, about 0.25% to about 0.60%, about 0.30% to about 0.60%, about 0.35% to about 0.60%, about 0.4% to about 0.6%, about 0.45% to about 0.6%, about 0.5% to about 0.6%, or about 0.55% to about 0.6%.

A polymer included in the polymeric separation medium is optionally cross-linked.

Optionally, a denaturing agent is included in the polymeric separation medium, such as a chaotropic agent, a detergent, or a mixture thereof.

According to aspects of methods of assessing a proportion of supercoiled plasmid DNA compared to linear plasmid DNA, and/or open circle plasmid DNA in a fluid sample comprising plasmid DNA in a fluid sample of the present disclosure, a denaturing agent is included in the polymeric separation medium. According to aspects of methods of assessing a proportion of supercoiled plasmid DNA compared to linear plasmid DNA, and/or open circle plasmid DNA in a fluid sample comprising plasmid DNA in a fluid sample of the present disclosure, a denaturing agent included in the polymeric separation medium is, or includes, a chaotropic agent, a detergent, or a mixture thereof.

The denaturing agent can be, or include, a chaotropic agent, such as a thiocyanate salt such as guanidinium thiocyanate, sodium thiocyanate, potassium thiocyanate, or any combination of two or more thereof; n-butanol; ethanol; guanidinium chloride; lithium perchlorate; lithium acetate; magnesium chloride; phenol; 2-propanol; sodium dodecyl sulfate; lithium dodecyl sulfate; thiourea; formamide; urea; DMSO or a combination of any two or more thereof.

The denaturing agent can be, or include, a detergent. The detergent can be an anionic, cationic, zwitterionic, or non-ionic detergent, such as Triton X-100; Triton X-114; NP-40; Tween-20; Tween-80; octyl-beta-glucoside; octylthio glucoside; ethyl trimethyl ammonium bromide; sodium dodecyl sulfate (SDS); Brij-35; Brij-58; CHAPS; CHAPSO; or a combination of any two or more thereof.

The polymeric separation medium may be uniform with respect to pore size along the length of a microchannel in which it is disposed. Alternatively, the polymeric separation medium may be disposed in a non-uniform manner in the microchannel, such as in a smooth gradient of pore size; or in two or more blocks of uniform pore size to achieve a “step” gradient.

According to aspects of methods of assessing a proportion of supercoiled plasmid DNA compared to linear plasmid DNA, and/or open circle plasmid DNA in a fluid sample comprising plasmid DNA in a fluid sample of the present disclosure, one or more stabilizers is included in the polymeric separation medium.

The term “stabilizer” as used herein refers to a substance which stabilizes pDNA in the polymeric separation medium such that the proportion of supercoiled plasmid DNA compared to linear plasmid DNA, and/or open circle plasmid DNA in the fluid sample remains substantially the same while the pDNA is flowing through the polymeric separation medium in a microfluidic device. A stabilizer further aids in efficient electrophoretic separation.

According to aspects of the present disclosure, the one or more stabilizers included in the polymeric separation medium is or includes one or more of stabilizers selected from the following: urea, magnesium chloride (MgCl₂), tris(hydroxymethyl)methylamino]propanesulfonic acid (TAPS), Tris/Borate/EDTA (TBE), and Tris-acetate-EDTA (TAE).

According to aspects of the present disclosure, the one or more stabilizers included in the polymeric separation medium is or includes one or more of: about 1 mM to about 5 mM MgCl₂ (magnesium chloride); about 5 to about 50 mM Tris Borate EDTA Buffer; about 10 to about 20 mM Tris Buffer, about 10 to about 20 mM Tris HCL Buffer, about 5% to about 30% TAPS buffer (N-Tris(hydroxymethyl)methyl-3-aminopropanesulfonic acid), about 5-15% Tris-acetate-EDTA (TAE), about 5-10% Tris/Borate/EDTA (TBE), about 5 to about 50 mM HEPES (2-[4-(2-hydroxy ethyl) piperazin-1-yl], about 0.1M to about 1M Urea, and about 10 to about 50 mM ethane sulfonic acid) with boric acid.

According to aspects of the present disclosure, the polymeric separation medium includes about 0.1% to about 0.6% polymer gel; about 5% to about 30% TAPS buffer (N-Tris(hydroxymethyl)methyl-3-aminopropanesulfonic acid), and about 0.1M to about 1M Urea, has a conductivity of about 1 ms/cm to about 3 ms/cm, and has a viscosity of about 0.2 ml/g to about 0.5 ml/g.

According to aspects of the present disclosure, the polymeric separation medium includes about 0.1% to about 0.6% polydimethylacrylamide (PDMA), having an average molecular weight in the range of about 80 kDa to about 800 kDa; about 5% to about 30% TAPS buffer (N-Tris(hydroxymethyl)methyl-3-aminopropanesulfonic acid), and about 0.1M to about 1M Urea, has a conductivity of about 1 ms/cm to about 3 ms/cm, and has a viscosity of about 0.2 ml/g to about 0.5 ml/g.

### Flowing

Typically, flowing the labeled plasmid DNA through the polymeric separation medium in the microchannel is performed at a temperature in the range of about 4° C. to about 30° C. According to aspects of the present disclosure, flowing the labeled plasmid DNA through the polymeric separation medium in the microchannel is performed at a temperature in the range of about 4° C. to about 10° C., 10° C. to about 15° C., 15° C. to about 20° C., 20° C. to about 25° C., 25° C. to about 30° C., or about 30° C. to about 40° C.

Typically, flowing the labeled plasmid DNA through the polymeric separation medium in the microchannel includes flow into a detection region in fluid communication with the microchannel, the detection region in signal communication with a sensor capable of detecting a signal from the detectable label of the labeled plasmid DNA.

The labeled plasmid DNA is flowed through the polymeric separation medium to separate different forms of labeled plasmid DNA, i.e. supercoiled, linear, and circular. Flow through the polymeric separation medium from one position in the microchannel towards a distant position in the microchannel is achieved by capillary action, diffusion, hydrodynamic action, and/or promoted by application of pressure gradient, voltage gradient, or a combination of two or more thereof.

Where the microchannel is approximately columnar, flow through the polymeric separation medium from one end of the microchannel towards a distant opposed end of the microchannel is achieved by capillary action, diffusion, hydrodynamic action, and/or promoted by application of pressure gradient, voltage gradient, current gradient, or a combination of two or more thereof along the length of the microchannel.

According to aspects of the present disclosure, a voltage gradient or current gradient is applied to promote flow through the polymeric separation medium from one end of the microchannel towards a distant opposed end of the microchannel. According to aspects of the present disclosure, the applied voltage is in the range of about 1500V to about 2900V, such as about 1500V to about 1600V, about 1500V to about 1700V, about 1500V to about 1800V, about 1500V to about 1900V, about 1500V to about 2000V, about 1500V to about 2100V, about 1500V to about 2200V, about 1500V to about 2300V, about 1500V to about 2400V, about 1500V to about 2500V, about 1500V to about 2600V, about 1500V to about 2700V, about 1500V to about 2800V, about 1600V to about 2900V, about 1700V to about 2900V, about 1800V to about 2900V, about 1900V to about 2900V, about 2000V to about 2900V, about 2100V to about 2900V, about 2200V to about 2900V, about 2300V to about 2900V, about 2400V to about 2900V, about 2500V to about 2900V, about 2600V to about 2900V, about 2700V to about 2900V, about 2800V to about 2900V, about 1500V to about 2000V, about 2000V to about 2500V, or about 2500V to about 2900V.

According to aspects of the present disclosure, the plasmid DNA or the labeled plasmid DNA is introduced into the well and/or microchannel by application of a stimulus effective to urge the movement of the plasmid DNA or the labeled plasmid DNA into the well and/or microchannel of the microfluidic device.

According to aspects of the present disclosure, the plasmid DNA or the labeled plasmid DNA is introduced into the well and/or microchannel by electrokinetic injection from an application device into a well and/or microchannel of a microfluidic device. Electrokinetic injection includes applying a voltage difference to electrokinetically move the plasmid DNA or labeled plasmid DNA from an application device into a well and/or microchannel of a microfluidic device. According to aspects of the present disclosure, the applied voltage is in the range of about 1500V to about 2900V, such as about 1500V to about 1600V, about 1500V to about 1700V, about 1500V to about 1800V, about 1500V to about 1900V, about 1500V to about 2000V, about 1500V to about 2100V, about 1500V to about 2200V, about 1500V to about 2300V, about 1500V to about 2400V, about 1500V to about 2500V, about 1500V to about 2600V, about 1500V to about 2700V, about 1500V to about 2800V, about 1600V to about 2900V, about 1700V to about 2900V, about 1800V to about 2900V, about 1900V to about 2900V, about 2000V to about 2900V, about 2100V to about 2900V, about 2200V to about 2900V, about 2300V to about 2900V, about 2400V to about 2900V, about 2500V to about 2900V, about 2600V to about 2900V, about 2700V to about 2900V, about 2800V to about 2900V, about 1500V to about 2000V, about 2000V to about 2500V, or about 2500V to about 2900V.

According to aspects of the present disclosure, the plasmid DNA or the labeled plasmid DNA is introduced into the well and/or microchannel by application of pressure effective to move the plasmid DNA or the labeled plasmid DNA from an application device into a well and/or microchannel of a microfluidic device.

Following introduction into a well and/or microchannel of a microfluidic device, the labeled plasmid DNA is flowed through the polymeric separation medium in the microchannel into a detection region in fluid communication with the microchannel, the detection region in signal communication with a sensor capable of detecting a signal from the detectable label of the labeled plasmid DNA.

Non-limiting examples of sensors capable of detecting a signal from the detectable label of the labeled plasmid DNA include a charge-coupled device (CCD), electron-multiplying CCD, photomultiplier tube, photosensitive diode, a complementary metal-oxide semiconductor (CMOS), an intensified charge-coupled device (ICCD), and an avalanche photodiode.

According to aspects of the present disclosure, the detected signal could be an absorption or a fluorescent signal emitted from a label as a result of contact with electromagnetic radiation which excites the label.

The detected signal may be measured to determine one or more quantitative aspects of the sample, such as one or more of: a) an amount of time taken by the different types of labeled plasmid DNA, i.e. supercoiled plasmid DNA, linear plasmid DNA, and circular plasmid DNA, to flow through the polymeric separation medium in the microchannel into the detection region, indicative of size of the different types of labeled plasmid DNA in the fluid sample, and/or b) strength of the signal of the detectable label in the detection region, representative of the amount of the different types of labeled plasmid DNA present, and indicative of concentration of the different types of plasmid DNA in the fluid sample, i.e. one or more of supercoiled plasmid DNA, linear plasmid DNA, and circular plasmid DNA. The detected signal(s) allow for assessment of the proportion of supercoiled plasmid DNA compared to linear plasmid DNA, and/or open circle plasmid DNA in a fluid sample containing plasmid DNA.

According to aspects of the present disclosure, the detector is operably connected to a computer which stores and manipulates the detected signal information, for example, to calculate one or more parameters relevant to the different types of plasmid DNA in the fluid sample. According to aspects of the present disclosure, the detector is operably connected to a computer which stores and manipulates the detected signal information, for example, to compare the detected signal information to one or more of: a) a reference standard representative of supercoiled plasmid DNA, b) a reference standard representative of linear plasmid DNA, and c) a reference standard representative of circular plasmid DNA. Based on the comparison of the detected signal information with an appropriate standard or standards, a characteristic of the plasmid DNA in the fluid sample is determined, such as 1) size of one or more different types of labeled plasmid DNA in the fluid sample is detected, and/or 2) the amount of one or more different types of labeled plasmid DNA in the fluid sample is detected and/or 3) at least one ratio of one type of plasmid DNA to another type of plasmid DNA in the sample, such as a ratio of supercoiled plasmid DNA to linear plasmid DNA, a ratio of supercoiled plasmid DNA to circular plasmid DNA, and/or a ratio of linear plasmid DNA to circular plasmid DNA. The detected signal(s) allow for assessment of the proportion of supercoiled plasmid DNA compared to linear plasmid DNA, and/or open circle plasmid DNA in a fluid sample containing plasmid DNA.

According to aspects of the present disclosure, the detector is operably connected to a computer which stores and manipulates the detected signal information, for example, to compare the detected signal information to one or more of: a) a reference standard representative of supercoiled plasmid DNA, b) a reference standard representative of linear plasmid DNA, and c) a reference standard representative of circular plasmid DNA. Based on the comparison of the detected signal information with an appropriate standard or standards, a characteristic of the plasmid DNA in the fluid sample is determined, such as 1) size of one or more different types of labeled plasmid DNA in the fluid sample is detected, and/or 2) the amount of one or more different types of labeled plasmid DNA in the fluid sample is detected and/or 3) at least one ratio of one type of plasmid DNA to another type of plasmid DNA in the sample, such as a ratio of supercoiled plasmid DNA to linear plasmid DNA, a ratio of supercoiled plasmid DNA to circular plasmid DNA, and/or a ratio of linear plasmid DNA to circular plasmid DNA. The detected signal(s) allow for assessment of the proportion of supercoiled plasmid DNA compared to linear plasmid DNA, and/or open circle plasmid DNA in a fluid sample containing plasmid DNA.

A reference standard can be any suitable reference standard, such as, but not limited to, one or more known sizes of supercoiled, linear, or circular plasmid DNA. A reference standard may be one or more known amounts of supercoiled, linear, or circular plasmid DNA. A reference standard may be analyzed at the same time as the fluid sample, e.g. added to the fluid sample, or maybe analyzed in parallel, e.g. under similar or the same analysis conditions.

Methods of assessing a proportion of supercoiled plasmid DNA compared to linear plasmid DNA, and/or open circle plasmid DNA in a fluid sample including or putatively including plasmid DNA in a fluid sample are provided according to aspects of the present disclosure.

The term “fluid” as used herein in reference to a sample refers to a liquid, gel, or combination of liquid and gel, that can be flowed through a microchannel. According to aspects of the present disclosure, the fluid is an aqueous fluid. According to aspects of the present disclosure, the fluid is an aqueous buffer such as, but not limited to, a Tris buffer, a Tricine buffer, a citrate buffer, a HEPES buffer, a carbonate buffer, a phosphate buffer, a MOPS buffer, a TAPS buffer, and an acetate buffer. Typically, the pH of the aqueous buffer is in the range of about pH 5.0 to about pH 9. According to aspects of the present disclosure, the pH of the aqueous buffer is about pH 5.0 to about pH 5.5, pH 6.0 to about pH 6.5, about pH 6.5 to about pH 7.0, about pH 7.0 to about pH 7.5, about pH 7.5 to about pH 8.0, about pH 8.0 to about pH 8.3, or about pH 8.3 to about pH 9.

The term “sample” as used herein refers to any material that includes, or may include, plasmid DNA of interest.

Optionally, a sample is purified prior to introduction into a microchannel of a microfluidic device. The term “purified” as used herein refers to reduction of at least some contaminating substances such that the purified sample contains a higher amount of plasmid DNA weight/weight than an unpurified sample. According to aspects of the present disclosure, a sample is purified such that contaminating substances in the sample are reduced by at least about 10% or more, at least about 20% or more, at least about 30% or more, at least about 40% or more, at least about 50% or more, at least about 60% or more, at least about 70% or more, at least about 80% or more, at least about 90% or more, or at least about 95% or more.

All of a sample, or a portion thereof, may be analyzed according to methods of the present disclosure. The term “aliquot of the fluid sample” refers to a portion of the fluid sample for analysis. The fluid sample, or aliquot thereof, typically has a volume in the range of about 0.5 microliter to about 50 microliters. According to aspects of the present disclosure, the fluid sample, or aliquot thereof, has a volume in the range of about 0.5 microliter to about 5 microliters, about 1 microliter to about 10 microliters, about 1 microliter to about 20 microliters, about 5 microliters to about 10 microliters, about 5 microliters to about 15 microliters, about 5 microliters to about 20 microliters, about 10 microliters to about 15 microliters, about 15 microliters to about 20 microliters, about 25 microliters to about 30 microliters, about 30 microliters to about 35 microliters, about 35 microliters to about 40 microliters, about 40 microliters to about 45 microliters, or about 45 microliters to about 50 microliters. According to aspects of the present disclosure, the fluid sample, or aliquot thereof, has a volume in the range of about 0.5 microliter, about 1 microliter, about 2 microliters, about 3 microliters, about 4 microliters, about 5 microliters, about 6 microliters, about 7 microliters, about 8 microliters, about 9 microliters, or about 10 microliters.

According to aspects of the present disclosure, the plasmid DNA in the fluid sample is present in a concentration in the range of about 0.025 ng/μl to about 15.0 ng/μl. According to aspects of the present disclosure, the plasmid DNA in the fluid sample is present in a concentration in the range of about 0.1 ng/μl to about 15.0 ng/μl. According to aspects of the present disclosure, the plasmid DNA in the fluid sample is present in a concentration in the range of about 0.025 ng/μl to about 15.0 ng/μl, about 0.05 ng/μl to about 15.0 ng/μl, about 0.075 ng/μl to about 15.0 ng/μl, about 0.1 ng/μl to about 15.0 ng/μl, about 0.25 ng/μl to about 15.0 ng/μl, about 0.5 ng/μl to about 15.0 ng/μl, about 1.0 ng/μl to about 15.0 ng/μl, about 2.5 ng/μl to about 15.0 ng/μl, about 5.0 ng/μl to about 15.0 ng/μl, about 10.0 ng/μl to about 15.0 ng/μl, about 12.5 ng/μl to about 15.0 ng/μl, about 0.025 ng/μl to about 10.0 ng/μl, about 0.1 ng/μl to about 10.0 ng/μl, about 0.25 ng/μl to about 10.0 ng/μl, about 0.5 ng/μl to about 2.5 ng/μl, about 1.0 ng/μl to about 10.0 ng/μl, about 2.5 ng/μl to about 5.0 ng/μl, about 5.0 ng/μl to about 15.0 ng/μl, about 10.0 ng/μl to about 15.0 ng/μl, or about 12.5 ng/μl to about 15.0 ng/μl.

According to aspects of the present disclosure, the plasmid DNA in the fluid sample has a size in the range of about 2000 to about 7000 nucleotides in length, such as about 2000 to about 2500 nucleotides in length, about 2500 to about 3000 nucleotides in length, about 3000 to about 3500 nucleotides in length, about 3500 to about 4000 nucleotides in length, about 4000 to about 4500 nucleotides in length, about 4500 to about 5000 nucleotides in length, about 5000 to about 5500 nucleotides in length, about 5500 to about 6000 nucleotides in length, about 6000 to about 6500 nucleotides in length, or about 6500 to about 7000 nucleotides in length.

According to aspects of the present disclosure, the plasmid DNA in the fluid sample has a size in the range of about 2000 to about 19000 nucleotides in length, such as about 2000 to about 18000 nucleotides in length, such as about 2000 to about 17000 nucleotides in length, such as about 2000 to about 16000 nucleotides in length, such as about 2000 to about 15000 nucleotides in length, such as about 2000 to about 14000 nucleotides in length, such as about 2000 to about 13000 nucleotides in length, such as about 2000 to about 12000 nucleotides in length, such as about 2000 to about 11000 nucleotides in length, such as about 2000 to about 10000 nucleotides in length, such as about 2000 to about 8000 nucleotides in length, such as about 2000 to about 8500 nucleotides in length, such as about 2000 to about 8000 nucleotides in length, such as about 2000 to about 2500 nucleotides in length, about 2500 to about 3000 nucleotides in length, about 3000 to about 3500 nucleotides in length, about 3500 to about 4000 nucleotides in length, about 4000 to about 4500 nucleotides in length, about 4500 to about 5000 nucleotides in length, about 5000 to about 5500 nucleotides in length, about 5500 to about 6000 nucleotides in length, about 6000 to about 6500 nucleotides in length, or about 6500 to about 7000 nucleotides in length.

Embodiments of inventive compositions and methods are illustrated in the following examples. These examples are provided for illustrative purposes and are not considered limitations on the scope of inventive compositions and methods.

### EXAMPLES

### Materials and Methods

### Example 1

The supercoiled samples pBR322 and pTXB1 from New England Biolabs were diluted in TE buffer, pH 7.5 to the specified concentration. The linear samples were generated using BamHI-HF enzyme, following the protocol provided by the manufacturer, and diluted with TE buffer to the specified concentration. Similarly, the open circular samples were generated using Nb.BsmI enzyme, following the protocol provided by the manufacturer, and then diluted in TE buffer to the specified concentration. Once the samples were generated and combined, they were loaded onto a 96- or 384-well plate and transferred onto the LabChip GXII Touch.

### Example 2

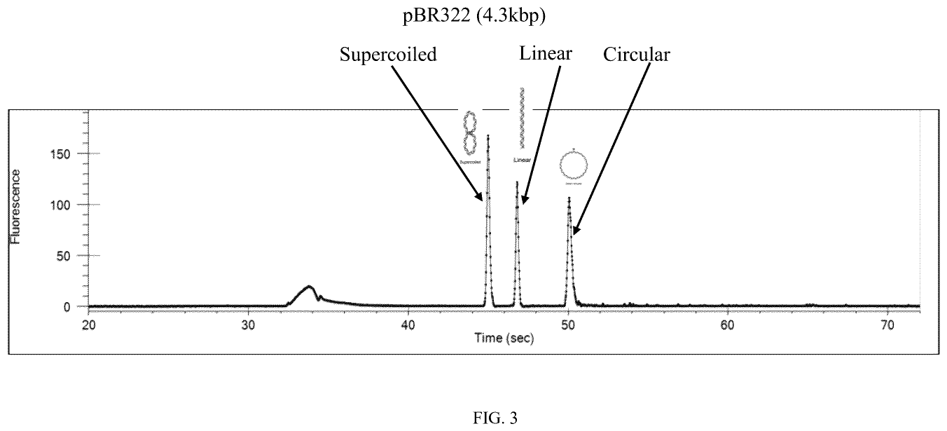

An example isoform resolution experiment is shown in FIG. 3. Plasmid DNA with length 4.3 kbp (pBR322 plasmid) was used as the starting material. A BamHI-HF digestion (as described in Example 1 and Nb.BsmI digestion experiment of Example 1 was used to generate three different samples, each containing the supercoiled isoform, linear isoform and open-circular isoform respectively. The samples were used neat following their enzymatic digestion to produce the diluted isoform mixture for resolution testing. These samples were mixed in an approximately 1:1:1 ratio and diluted with sample buffer at ˜pH 7-8. Each sample was ˜500 pg/μL concentration. A polydimethylacrylamide sieving matrix was used for analyte separation and loaded onto the chip. An on-chip labeling with single strand nucleic acid binding dye was used.

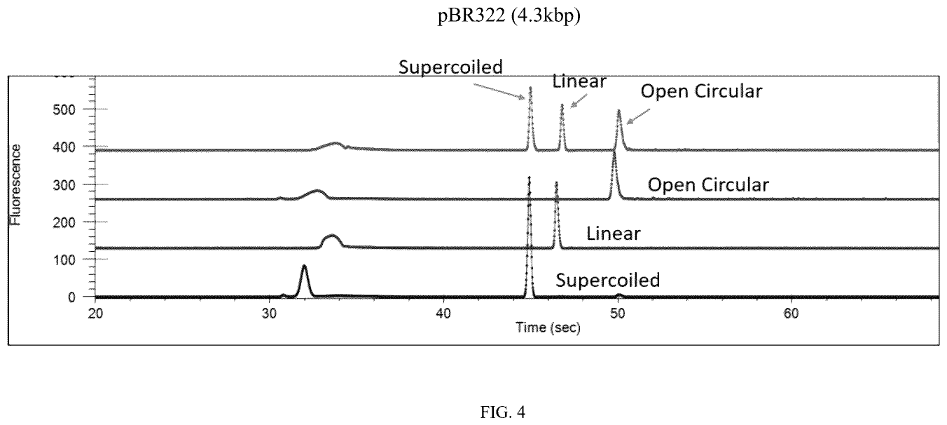

In the experiment shown in FIG. 4, each plasmid DNA isoform obtained from pBR322 was measured separately or mixed together (top line). The concentration of each sample is ˜500 pg/μL.

### Example 3

An example of an isoform resolution experiment using a larger molecular weight plasmid DNA sample (pTXB1) was measured. Each isoform of the sample was ˜500 pg/μL and diluted in buffer with pH˜7-8. A polydimethylacrylamide sieving matrix was used for separation. An on-chip labeling with single strand nucleic acid binding dye was used. Results are shown in FIG. 5 where each plasmid DNA isoform obtained from pBR322 was measured separately, or mixed together (top line).

### Example 4

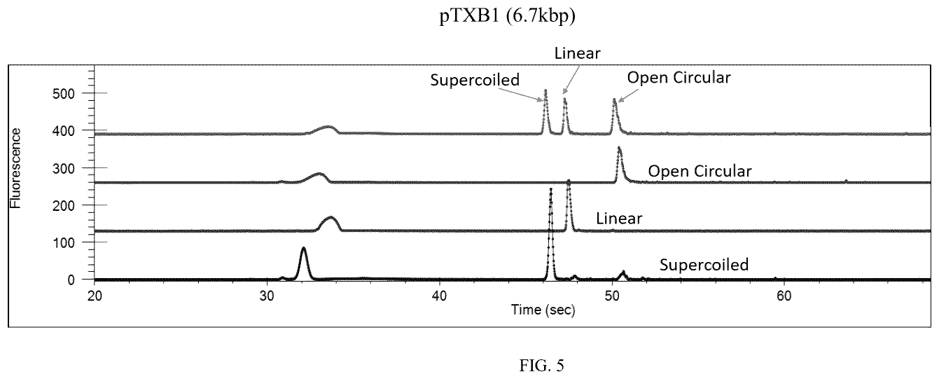

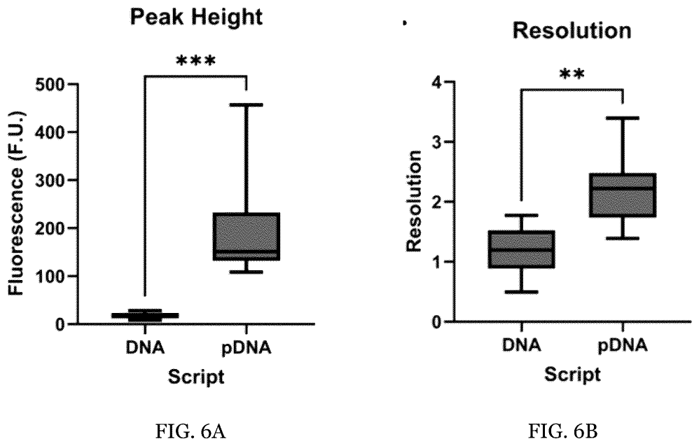

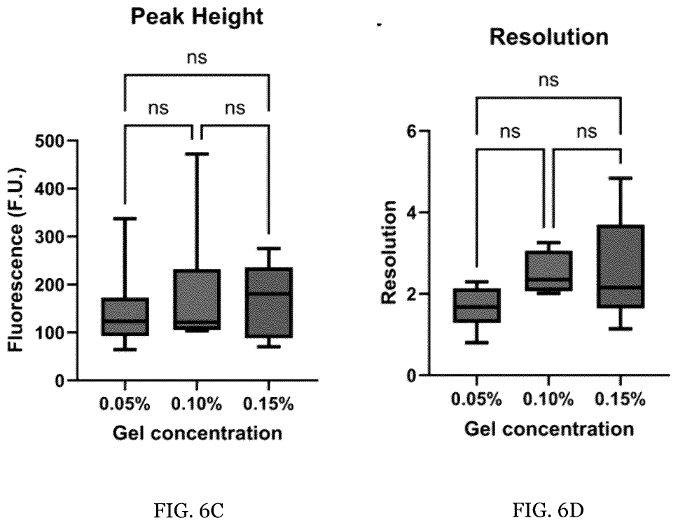

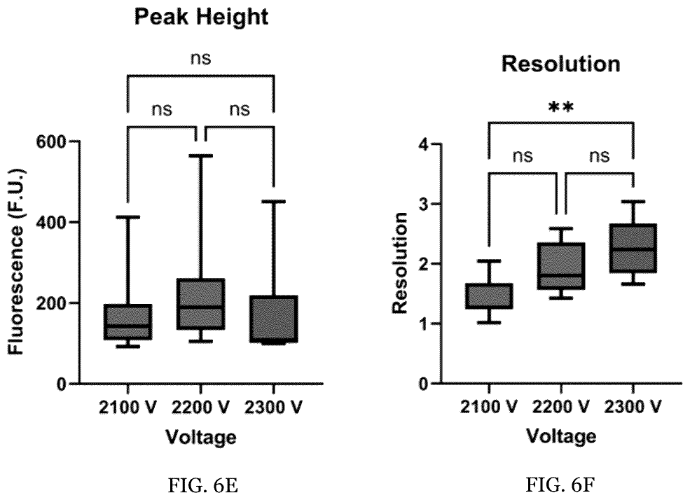

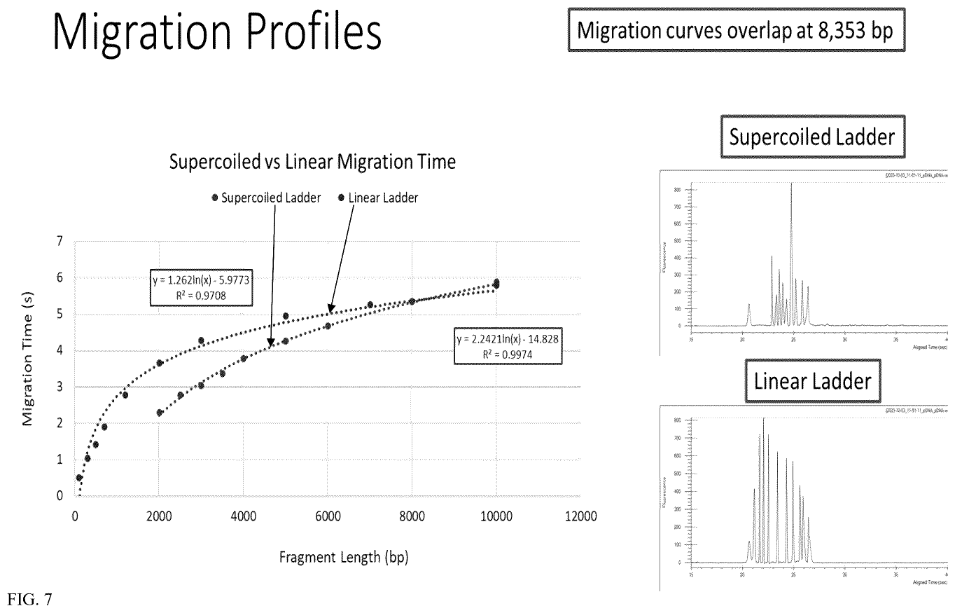

An example of sensitivity and resolution testing of supercoiled DNA ladder is shown in FIGS. 6A, 6B, 6C, 6D, 6E, and 6F. The supercoiled ladder contained sizes 2000, 2500, 3000, 3500, 4000, 5000, 6000, 8000 and 10000 kbp. Peak height is defined as the average peak height and serves as an indication of the assay sensitivity. Resolution was calculated based on the difference in peak migration times and full-width half maximums. Statistical analyses was completed in GraphPad Prism 9.4.1 with a confidence interval of 95% where * signifies p<0.05, **p<0.01, and ***p<0.001

### Example 5

An example of a separation experiment of supercoiled DNA isoforms by weight and linear DNA isoforms by weight are shown in FIG. 7. A polydimethylacrylamide sieving matrix and single stranded nucleic acid binding dye were loaded to the chip. A supercoiled ladder with sizes 2000, 2500, 3000, 3500, 4000, 5000, 6000, 8000 and 10000 kbp and linear ladder with sizes 100, 300, 500, 700, 1100 2900, 4900, 7000 and 10000 bp were tested. This formulation of polydimethylacrylamide and salt concentration showed supercoiled isoform and linear isoform of the same molecular weight have different mobility up to size ˜8353 basepairs.

### Example 6

To evaluate the detection of low-level impurities, supercoiled DNA samples of size (4.4 kb) were spiked with varying concentrations of linear and open circular plasmid DNA (10, 25, 50, and 100 pg/μL). The samples were analyzed in duplicate using the LabChip GXII Touch system according to aspects of methods of the present disclosure. For this, a polydimethylacrylamide sieving matrix and single stranded nucleic acid binding dye were loaded to the chip. The sieving matrix gel had a polymer concentration between 0.01% w/w to 0.1% w/w and TAPS concentration 5-15% wt/vol.

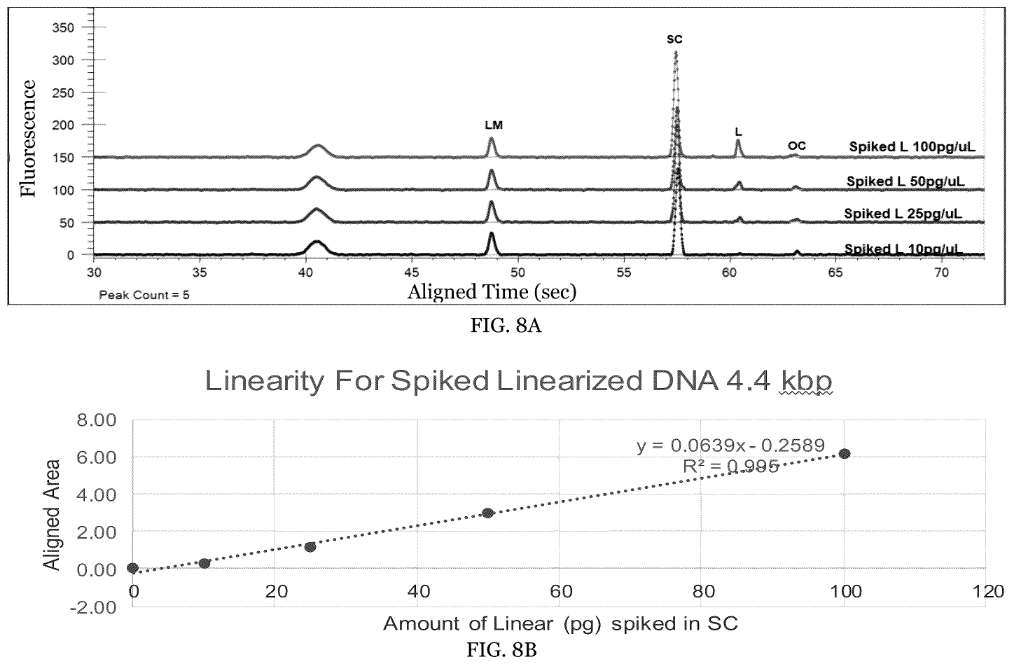

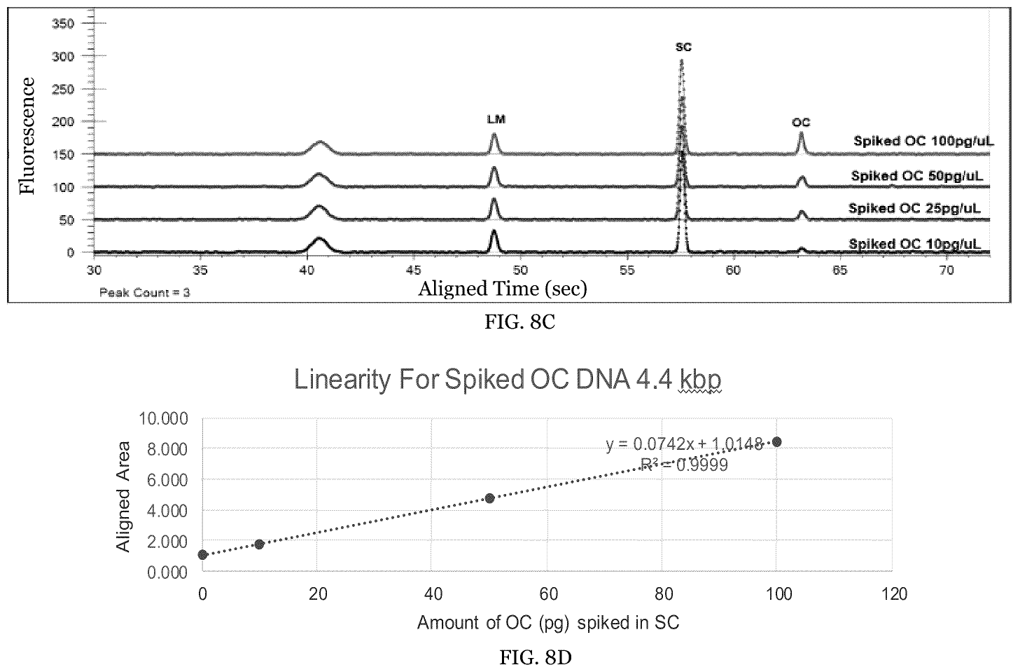

The results, displayed in FIGS. 8A and 8C, show an electropherogram overlay of the spiked impurities for the 4.4 kbp plasmid, indicating that higher impurity concentrations detected correlate with the increased areas under the impurity peaks. The limit of detection (LOD) for the linear and open circular isoforms was approximately 25 pg/μL (0.025 ng/μl) for the 4.4 kbp sample. Detection was linear as shown in FIGS. 8B and 8D.

### Example 7

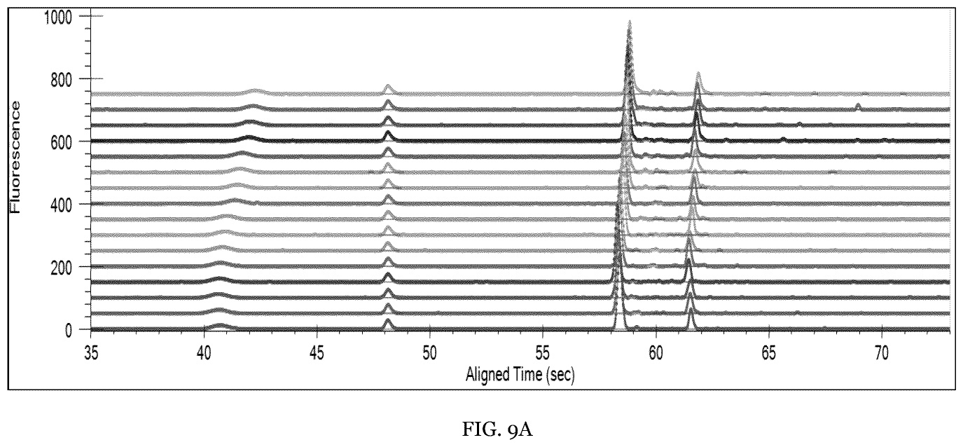

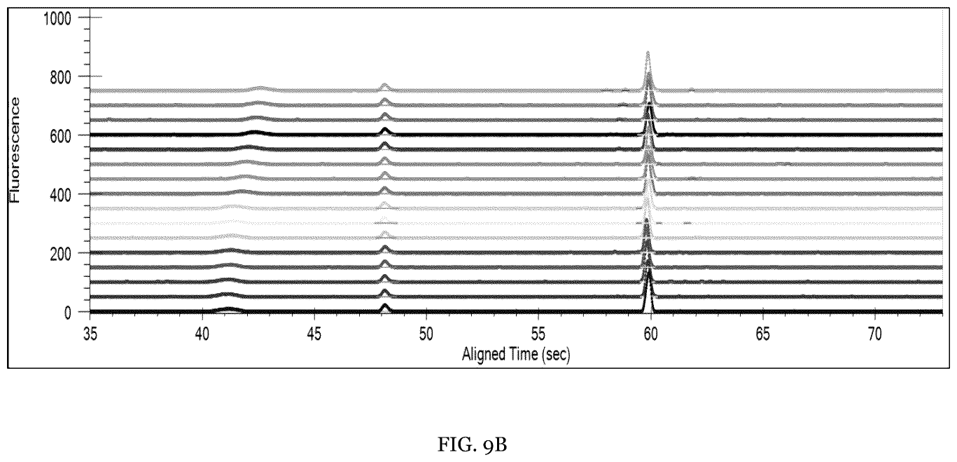

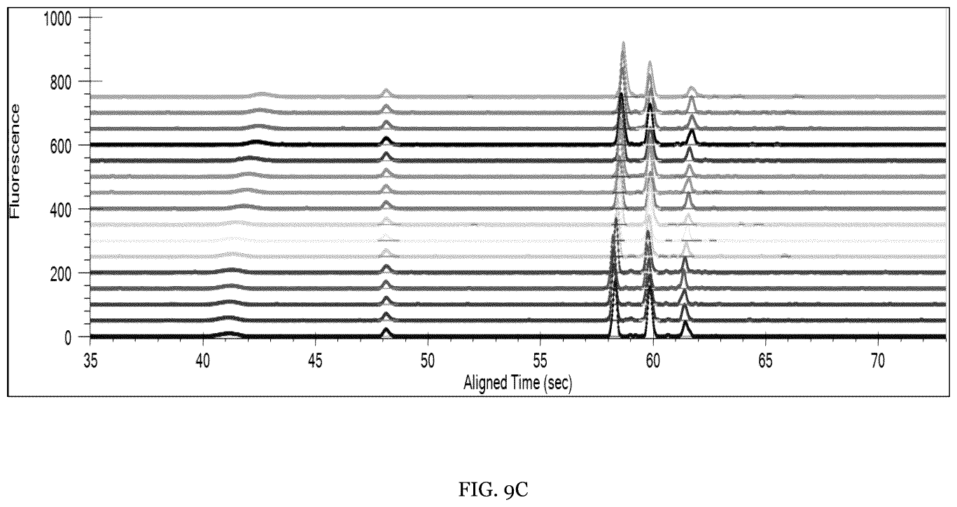

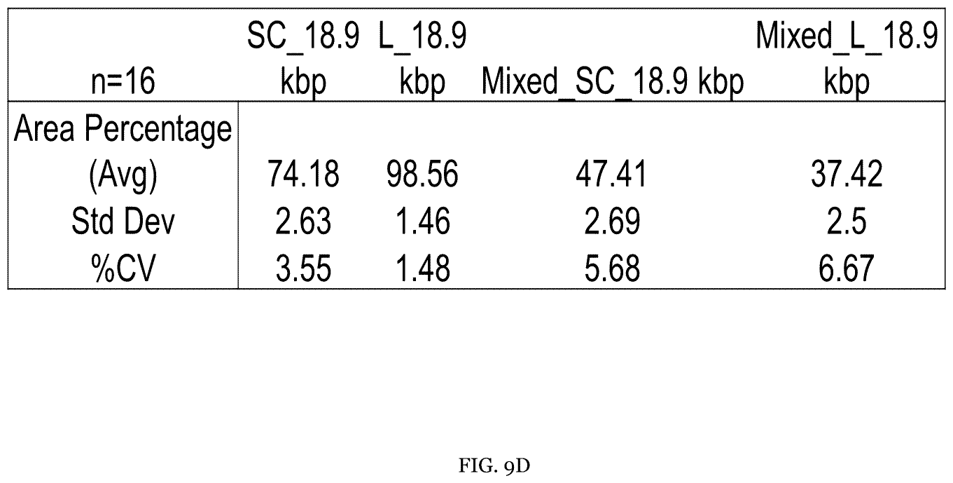

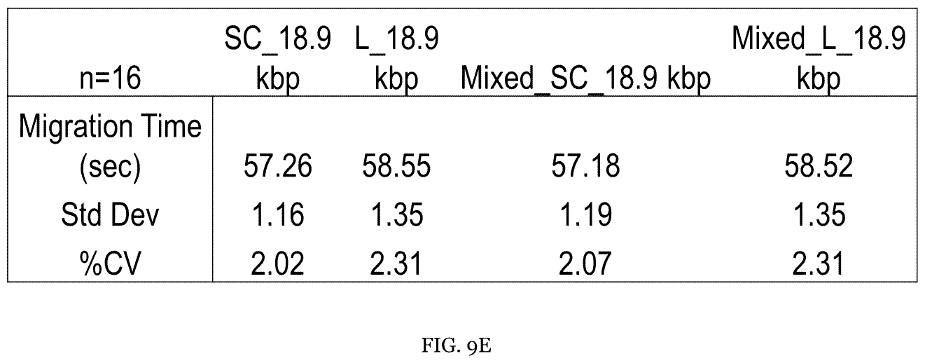

In this example, samples containing supercoiled and open circular isoforms, containing linear isoform only, or containing a mixture of supercoiled, linear, and open circular isoforms, of an 18.9 kbp (18900 bp) plasmid were assayed. Each sample was diluted to about 500 pg/μL and diluted in buffer with pH˜7-8. For the mixed isoform sample, supercoiled and linear pDNA were mixed 1:1 with final concentration 500 pg/μL each. A polydimethylacrylamide sieving matrix was used for separation. The sieving matrix gel had a polymer concentration between 0.1% w/w to 0.6% w/w and TAPS concentration 5-30% wt/vol. An on-chip labeling with single strand nucleic acid binding dye was used. Results are shown in FIGS. 9A, 9B, 9C, 9D, and 9E.

FIG. 9A is a graph displaying 16 electropherograms of the supercoiled isoform of an 18.9 kbp plasmid, also containing the open circular isoform, and both the supercoiled and open circular isoforms were resolved.

FIG. 9B is a graph displaying 16 electropherograms of the linear isoform of the same 18.9 kbp plasmid. Up to 2% of carryover was observed after 32 sips.

FIG. 9C is a graph displaying 16 electropherograms of samples containing a mixture of the linear isoform, the supercoiled isoform, and the open circular isoform, of the 18.9 kbp plasmid, and showing resolved peaks of the three isoforms.

FIG. 9D is a table showing “Area Percentage of Plasmids” for the separate or mixed supercoiled and linear isoforms of the 18.9 kbp plasmid. The percentage CV for Area percentage for the supercoiled and linear isoforms were calculated to <10%.

FIG. 9E is a graph showing “Migration Time (seconds) of Plasmids)” for the separate or mixed supercoiled and linear isoforms of the 18.9 kbp plasmid. The percentage CV for Migration time for the supercoiled and linear isoforms were calculated to <3%.

### Item List

Item 1. A method of assessing double-stranded plasmid DNA isoforms to determine a proportion of supercoiled plasmid DNA compared to linear plasmid DNA, and/or open circle plasmid DNA in a fluid sample comprising one or more double-stranded plasmid DNA isoforms, the method comprising: contacting the double-stranded plasmid DNA isoforms of the fluid sample with a detectable label which preferentially labels double-stranded plasmid DNA thereby labeling linear double-stranded plasmid DNA supercoiled double-stranded plasmid DNA, and open circle double-stranded plasmid DNA, producing labeled double-stranded plasmid DNA; flowing the labeled double-stranded plasmid DNA through a polymeric separation medium in a microchannel into a detection region in fluid communication with the microchannel, the microchannel having a first end, a second end, and length extending between the first end and the second end, the detection region in signal communication with at least one sensor capable of detecting a signal from the detectable label of the labeled double-stranded plasmid DNA, whereby supercoiled double-stranded plasmid DNA, linear double-stranded plasmid DNA, and open circle double-stranded plasmid DNA present in the labeled double-stranded plasmid DNA are detectably separated by flowing the labeled double-stranded plasmid DNA through the polymeric separation medium of the microchannel; detecting the detectable label of the labeled double-stranded plasmid DNA in the detection region to determine: a) an amount of time taken by the labeled plasmid DNA isoforms to flow through the polymeric separation medium in the microchannel into the detection region, indicative of a flow characteristic of the plasmid DNA isoforms in the fluid sample, and/or b) strength of the signal of the detectable label in the detection region, representative of the amount of supercoiled plasmid DNA, linear plasmid DNA, and open circle plasmid DNA present; and comparing a) and/or b) to a reference standard representative of one or more of: supercoiled plasmid DNA, linear plasmid DNA, and open circle plasmid DNA, and, based on the comparison, determining a proportion of supercoiled plasmid DNA compared to linear plasmid DNA, and open circle plasmid DNA in the fluid sample; thereby determining a proportion of supercoiled plasmid DNA compared to linear plasmid DNA, and/or open circle plasmid DNA in the fluid sample comprising plasmid DNA.

Item 2. The method of item 1, wherein the detectable label is an intercalating agent.

Item 3. The method of item 1, wherein labeling the plasmid DNA comprises introducing the plasmid DNA into a well and/or microchannel of a microfluidic device, the well and/or microchannel comprising the polymeric separation medium and a detectable label which labels plasmid DNA isoforms producing labeled plasmid DNA isoforms in the well and/or microchannel.

Item 4. The method of any one of items 1 to 3, wherein the plasmid DNA has a size in the range of about 2000 to about 19000 nucleic acid base pairs in length.

Item 5. The method of any one of items 1 to 4, wherein the plasmid DNA has a concentration in the range of about 0.025 ng/μl to about 50.0 ng/μl.

Item 6. The method of any one of items 1 to 5, wherein flowing the labeled plasmid DNA through the polymeric separation medium comprises application of a voltage gradient along the length of the microchannel between the first end and the second end, wherein the voltage gradient is in the range of about 1500V to about 2900V.

Item 7. The method of any one of items 3 to 6, wherein the labeled plasmid DNA is introduced into the well and/or microchannel by electrokinetic injection or pressure injection.

Item 8. The method of any one of items 1 to 7, wherein the polymeric separation medium comprises a polymer selected from the group consisting of: about 0.08% w/w to about 0.6% w/w hydroxypropyl methylcellulose (HPMC), having an average molecular weight in the range of about 80 kDa to about 120 kDa; about 0.08% w/w to about 0.6% w/w HPMC, having an average molecular weight in the range of about 90 kDa to about 160 kDa; about 0.08% w/w to about 0.6% w/w hydroxyethyl cellulose (HEC) having an average molecular weight in the range of about 90 kDa to about 160 kDa; about 0.08% w/w to about 0.6% w/w polyvinylpyrrolidone (PVP) having an average molecular weight in the range of about 90 kDa to about 130 kDa; about 0.05% w/w to about 0.6% w/w polydimethylacrylamide (PDMA), having an average molecular weight in the range of about 80 kDa to about 800 kDa; about 5% w/w polyacrylamide gel; and non-cross-linked polyacrylamide.

Item 9. The method of any one of items 1 to 8, wherein the polymeric separation medium comprises a buffer selected from the group consisting of: 1 mM-5 mM MgCl₂ (magnesium chloride); Tris Borate EDTA Buffer; HEPES (2-[4-(2-hydroxy ethyl) piperazin-1-yl] ethane sulfonic acid) with boric acid; Tris Buffer, and TAPS buffer (N-Tris(hydroxymethyl)methyl-3-aminopropanesulfonic acid).

Item 10. The method of any one of items 1 to 9, wherein the polymeric separation medium comprises a stabilizer.

Item 11. The method of item 10 wherein the stabilizer is selected from the group consisting of: urea, magnesium chloride (MgCl₂), tris(hydroxymethyl)methylamino]propanesulfonic acid (TAPS), Tris/Borate/EDTA (TBE), and Tris-acetate-EDTA (TAE).

Item 12. The method of any one of items 1 to 11, wherein the polymeric separation medium comprises: about 0.1% w/w to about 0.6% w/w polymer gel; about 5% to about 30% TAPS buffer (N-Tris(hydroxymethyl)methyl-3-aminopropanesulfonic acid), and about 0.1M to about 1M Urea, has a conductivity of about 1 ms/cm to about 3 ms/cm, and has a viscosity of about 0.2 ml/g to about 0.5 ml/g.

Item 13. The method of any one of items 1 to 12, wherein the polymeric separation medium comprises: about 0.1% w/w to about 0.6% w/w polydimethylacrylamide (PDMA), having an average molecular weight in the range of about 80 kDa to about 800 kDa; about 5% to about 30% TAPS buffer (N-Tris(hydroxymethyl)methyl-3-aminopropanesulfonic acid), and about 0.1M to about 1M Urea, has a conductivity of about 1 ms/cm to about 3 ms/cm, and has a viscosity of about 0.2 ml/g to about 0.5 ml/g

Item 14. A kit for assessing a proportion of supercoiled plasmid DNA compared to linear plasmid DNA, and/or open circle plasmid DNA in a fluid sample comprising plasmid DNA, comprising: a detectable nucleic acid label which labels double-stranded plasmid DNA isoforms, a polymeric separation medium, a nucleic acid standard, a nucleic acid storage buffer, and a nucleic acid sample buffer.

Item 15. The kit of item 14, wherein the detectable nucleic acid label is fluorescent nucleic acid intercalator.

Item 16. The kit of any of items 14 or 15 wherein the nucleic acid standard is a DNA ladder.

Item 17. A method of assessing a proportion of supercoiled plasmid DNA compared to linear plasmid DNA, and/or open circle plasmid DNA in a fluid sample comprising plasmid DNA substantially as shown or described herein.

Item 18. A kit for assessing a proportion of supercoiled plasmid DNA compared to linear plasmid DNA, and/or open circle plasmid DNA in a fluid sample comprising plasmid DNA substantially as shown or described herein.

Any patents or publications mentioned in this specification are incorporated herein by reference to the same extent as if each individual publication is specifically and individually indicated to be incorporated by reference.

The compositions and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

1. A method of assessing double-stranded plasmid DNA isoforms to determine a proportion of supercoiled plasmid DNA compared to linear plasmid DNA, and/or open circle plasmid DNA in a fluid sample comprising one or more double-stranded plasmid DNA isoforms, the method comprising:
contacting the double-stranded plasmid DNA isoforms of the fluid sample with a detectable label which preferentially labels double-stranded plasmid DNA thereby labeling linear double-stranded plasmid DNA supercoiled double-stranded plasmid DNA, and open circle double-stranded plasmid DNA, producing labeled double-stranded plasmid DNA;
flowing the labeled double-stranded plasmid DNA through a polymeric separation medium in a microchannel into a detection region in fluid communication with the microchannel, the microchannel having a first end, a second end, and length extending between the first end and the second end, the detection region in signal communication with at least one sensor capable of detecting a signal from the detectable label of the labeled double-stranded plasmid DNA, whereby supercoiled double-stranded plasmid DNA, linear double-stranded plasmid DNA, and open circle double-stranded plasmid DNA present in the labeled double-stranded plasmid DNA are detectably separated by flowing the labeled double-stranded plasmid DNA through the polymeric separation medium of the microchannel;
detecting the detectable label of the labeled double-stranded plasmid DNA in the detection region to determine: a) an amount of time taken by the labeled plasmid DNA isoforms to flow through the polymeric separation medium in the microchannel into the detection region, indicative of a flow characteristic of the plasmid DNA isoforms in the fluid sample, and/or b) strength of the signal of the detectable label in the detection region, representative of the amount of supercoiled plasmid DNA, linear plasmid DNA, and open circle plasmid DNA present; and
comparing a) and/or b) to a reference standard representative of one or more of: supercoiled plasmid DNA, linear plasmid DNA, and open circle plasmid DNA, and, based on the comparison, determining a proportion of supercoiled plasmid DNA compared to linear plasmid DNA, and open circle plasmid DNA in the fluid sample;
thereby determining a proportion of supercoiled plasmid DNA compared to linear plasmid DNA, and/or open circle plasmid DNA in the fluid sample comprising plasmid DNA.

2. The method of claim 1, wherein the detectable label is an intercalating agent.

3. The method of claim 1, wherein labeling the plasmid DNA comprises introducing the plasmid DNA into a well and/or microchannel of a microfluidic device, the well and/or microchannel comprising the polymeric separation medium and a detectable label which labels plasmid DNA isoforms producing labeled plasmid DNA isoforms in the well and/or microchannel.

4. The method of claim 1, wherein the plasmid DNA has a size in the range of about 2000 to about 19000 nucleic acid base pairs in length.

5. The method of claim 1, wherein the plasmid DNA has a concentration in the range of about 0.025 ng/μl to about 50.0 ng/μl.

6. The method of claim 1, wherein flowing the labeled plasmid DNA through the polymeric separation medium comprises application of a voltage gradient along the length of the microchannel between the first end and the second end, wherein the voltage gradient is in the range of about 1500V to about 2900V.

7. The method of claim 3, wherein the labeled plasmid DNA is introduced into the well and/or microchannel by electrokinetic injection or pressure injection.

8. The method of claim 1, wherein the polymeric separation medium comprises a polymer selected from the group consisting of: about 0.08% w/w to about 0.6% w/w hydroxypropyl methylcellulose (HPMC), having an average molecular weight in the range of about 80 kDa to about 120 kDa; about 0.08% w/w to about 0.6% w/w HPMC, having an average molecular weight in the range of about 90 kDa to about 160 kDa; about 0.08% w/w to about 0.6% w/w hydroxyethyl cellulose (HEC) having an average molecular weight in the range of about 90 kDa to about 160 kDa; about 0.08% w/w to about 0.6% w/w polyvinylpyrrolidone (PVP) having an average molecular weight in the range of about 90 kDa to about 130 kDa; about 0.05% w/w to about 0.6% w/w polydimethylacrylamide (PDMA), having an average molecular weight in the range of about 80 kDa to about 800 kDa; about 5% polyacrylamide gel; and non-cross-linked polyacrylamide.

9. The method of claim 1, wherein the polymeric separation medium comprises a buffer selected from the group consisting of: 1 mM-5 mM MgCl₂ (magnesium chloride); Tris Borate EDTA Buffer; HEPES (2-[4-(2-hydroxy ethyl) piperazin-1-yl] ethane sulfonic acid) with boric acid; Tris Buffer, and TAPS buffer (N-Tris(hydroxymethyl)methyl-3-aminopropanesulfonic acid).

10. The method of claim 1, wherein the polymeric separation medium comprises a stabilizer.

11. The method of claim 10 wherein the stabilizer is selected from the group consisting of: urea, magnesium chloride (MgCl₂), tris(hydroxymethyl)methylamino]propanesulfonic acid (TAPS), Tris/Borate/EDTA (TBE), and Tris-acetate-EDTA (TAE).

12. The method of claim 1, wherein the polymeric separation medium comprises: about 0.1% w/w to about 0.6% w/w polymer gel; about 5% to about 30% TAPS buffer (N-Tris(hydroxymethyl)methyl-3-aminopropanesulfonic acid), and about 0.1M to about 1M Urea, has a conductivity of about 1 ms/cm to about 3 ms/cm, and has a viscosity of about 0.2 ml/g to about 0.5 ml/g.

13. The method of claim 1, wherein the polymeric separation medium comprises: about 0.1% w/w to about 0.6% w/w polydimethylacrylamide (PDMA), having an average molecular weight in the range of about 80 kDa to about 800 kDa; about 5% to about 30% TAPS buffer (N-Tris(hydroxymethyl)methyl-3-aminopropanesulfonic acid), and about 0.1M to about 1M Urea, has a conductivity of about 1 ms/cm to about 3 ms/cm, and has a viscosity of about 0.2 ml/g to about 0.5 ml/g.

14. A kit for assessing a proportion of supercoiled plasmid DNA compared to linear plasmid DNA, and/or open circle plasmid DNA in a fluid sample comprising plasmid DNA, comprising:
a detectable nucleic acid label which labels double-stranded plasmid DNA isoforms, a polymeric separation medium, a nucleic acid standard, a nucleic acid storage buffer, and a nucleic acid sample buffer.

15. The kit of claim 14, wherein the detectable nucleic acid label is fluorescent nucleic acid intercalator.

16. The kit of claim 14, wherein the nucleic acid standard is a DNA ladder.
